(19) United States
(12) Patent Application Publication
(10) Pub. No.: US 2015/0245594 A1
(43) Pub. Date: Sep. 3, 2015

(54) Multi-leash handle

(71) Applicant: Francine Bernard, Hartsdale, NY (US)

(72) Inventor: Francine Bernard, Hartsdale, NY (US)

(21) Appl. No.: 14/629,385

(22) Filed: Feb. 23, 2015

Related U.S. Application Data
(60) Provisional application No. 61/945,983, filed on Feb. 28, 2014.

(51) Int. Cl. A01K 27/00

(52) U.S. Cl. CPC A01K 27/003

(57) ABSTRACT

A multi-leash handle, capable of securing more than one dog's leash. The handle forms an enclosure, opening to attach or remove the leashes easily, and features a flexible, ergonomic handgrip. In the first exemplary embodiment, the front bar of the handle features a hinged member, which closes with a latch. The front bar is cylindrical, with a smooth surface, and is used to retain the rings at the ends of the leashes. At the other end of each leash is a clip, to be secured to the dog's collar. The handgrip is provided on the rear of the handle. One leash is provided with the handle. Additional leashes in assorted sizes and colors are available separately.

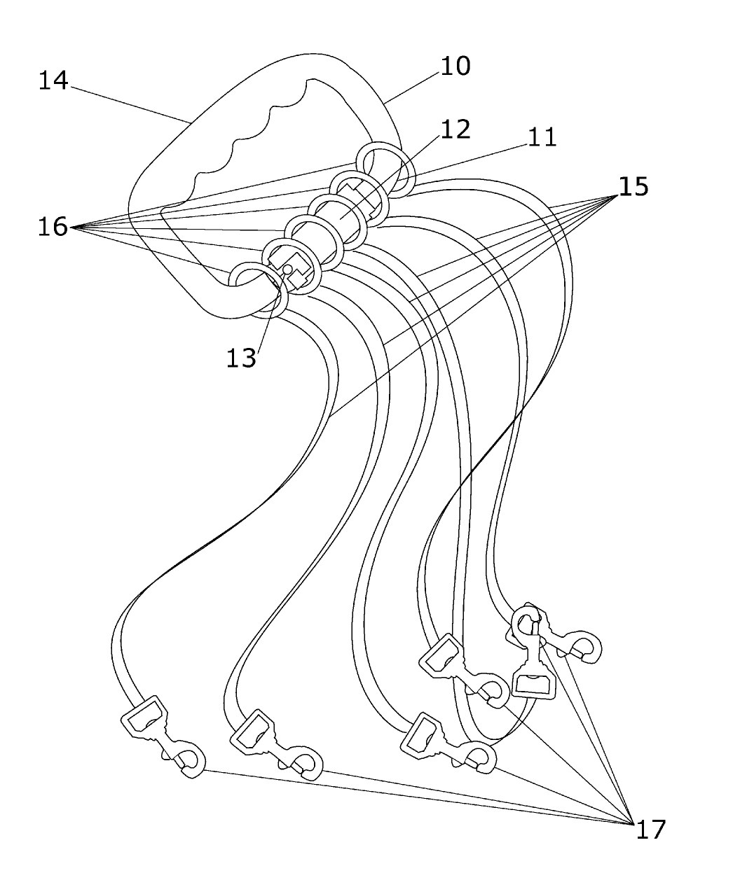

### CROSS-REFERENCE TO RELATED APPLICATIONS

This application claims the benefit of U.S. Provisional Application No. 61/945,983, filed Feb. 28, 2014, which is hereby incorporated by reference.

### STATEMENT REGARDING FEDERALLY SPONSORED RESEARCH OR DEVELOPMENT

Not Applicable

### PARTIES TO A JOINT RESEARCH AGREEMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The invention relates generally to pet care accessories, and in particular to a multi-leash handle. Many dog owners own more than one dog, and dog walkers often walk multiple dogs at the same time. Safely managing multiple animals can be difficult, as dogs have minds of their own and they often walk in different directions, tangling the leashes and possibly breaking them loose from their owner's grip. This is particularly true for those owners who are elderly or disabled, or have multiple large dogs. However, capably handling more than one leash would give the dogs more space and more freedom. A multi-leash handle, capable of securing more than one dog's leash, would resolve this problem.

### SUMMARY OF THE INVENTION

Accordingly, the invention is directed to a multi-leash handle, capable of securing more than one dog's leash. The handle forms an enclosure, opening to attach or remove the leashes easily, and features a flexible, ergonomic handgrip. In the first exemplary embodiment, the front bar of the handle features a hinged member, which closes with a latch. The front bar is cylindrical, with a smooth surface, and is used to retain the rings at the ends of the leashes. At the other end of each leash is a clip, to be secured to the dog's collar. The handgrip is provided on the rear of the handle. One leash is provided with the handle. Additional leashes in assorted sizes and colors are available separately.

Additional features and advantages of the invention will be set forth in the description which follows, and will be apparent from the description, or may be learned by practice of the invention. The foregoing general description and the following detailed description are exemplary and explanatory and are intended to provide further explanation of the invention.

### BRIEF DESCRIPTION OF THE DRAWING

The accompanying drawing is included to provide a further understanding of the invention and is incorporated into and constitutes a part of the specification. It illustrates one embodiment of the invention and, together with the description, serves to explain the principles of the invention.

The FIGURE is a front view of the first exemplary embodiment, displaying the handle 10, the front bar 11, the hinged member 12, the latch 13, the handgrip 14, the leashes 15, the rings 16, and the clips 17.

### DETAILED DESCRIPTION OF THE INVENTION

Referring now to the invention in more detail, the invention is directed to a multi-leash handle 10, capable of securing more than one dog's leash 15. The handle 10 forms an enclosure, opening to attach or remove the leashes 15 easily, and features a flexible, ergonomic handgrip 14.

The first exemplary embodiment is directed to use by persons who walk more than one dog. The handle 10 is loop-shaped having a hand grip 14 opposite a front bar 11; both are portions of the handle 10. The front bar 11 is openable and reclosable via a hinged member 12, which closes with a latch 13. The front bar 11 is cylindrical, with a smooth surface, and is used to retain the rings 16 interlinked thereon. The rings 16 are also attached to the ends of the leashes 15, and the rings 16 are detachable and replaceable via opening the hinged member 12. At the other end of each leash 15 is a clip 17, to be secured to the dog's collar. The handgrip 14 is provided on the rear of the handle 10. One leash 15 is provided with the handle 10. Additional leashes 15 in assorted sizes and colors are available separately.

To use the first exemplary embodiment, the user may open the latch 13 and raise the hinged member 12. The user may then provide a number of rings 16 at least equal to the number of dogs that the user wishes to walk simultaneously. The user then secures the ring 16 of each leash 15 to the front bar 11, such that the front bar 11 passes through the ring 16. The user then closes and secures the latch 13, and attaches the clip 17 at the end of each leash 15 to a dog's collar. The user may then take the dogs for a walk, holding the handgrip 14.

The front bar 11, the hinged member 12, the latch 13, the rings 16, and the clips 17 are preferably manufactured from rigid, durable materials such as steel, brass, and aluminum alloys. The handgrip 14 is preferably manufactured from a flexible, durable material such as silicone or foam rubber. The leashes 15 are preferably manufactured from a flexible, durable material such as leather or nylon webbing. Components, component sizes, and materials listed above are preferable, but artisans will recognize that alternate components and materials could be selected without altering the scope of the invention.

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above described embodiment, method, and examples, but by all embodiments and methods within the scope and spirit of the invention.

I claim:

1. A multi-leash handle comprising:
(a) a handle;
(b) a front bar, said front being a portion of said handle;
(c) said front bar being openable;
(d) said front bar being interlinked with a plurality of rings; and
(e) each of said plurality of rings having a leash affixed thereto.

2. The multi-leash handle of claim 1 further comprising a hand grip; said hand grip being a portion of said handle.

3. The multi-leash handle of claim 1 wherein said front bar is openable via a hinged member; said hinged member being closed via a latch.

4. The multi-leash handle of claim 2 wherein said front bar is openable via a hinged member; said hinged member being closed via a latch.

5. The multi-leash handle of claim 1 wherein said leash terminates in a clip opposite that of said plurality of rings to which said leash is affixed.

6. The multi-leash handle of claim 2 wherein said leash terminates in a clip opposite that of said plurality of rings to which said leash is affixed.

7. The multi-leash handle of claim 3 wherein said leash terminates in a clip opposite that of said plurality of rings to which said leash is affixed.

8. The multi-leash handle of claim 4 wherein said leash terminates in a clip opposite that of said plurality of rings to which said leash is affixed.

9. A method of using a multi-leash handle, the multi-leash handle comprising:
(a) a handle;
(b) a front bar, said front being a portion of said handle;
(c) said front bar being openable;
(d) said front bar being interlinked with a plurality of rings; and
(e) each of said plurality of rings having a leash affixed thereto;
and the method comprising:
(f) providing a plurality of dogs;
(g) providing said plurality of rings in a number at least equal to that of said plurality of dogs;
(h) for each of said plurality of dogs, affixing said leash thereto;
(i) holding said handle; and
(j) walking said plurality of dogs simultaneously while holding said handle.

10. The method of using a multi-leash handle of claim 9 further comprising a hand grip; said hand grip being a portion of said handle.

11. The method of using a multi-leash handle of claim 9 wherein said front bar is openable via a hinged member; said hinged member being closed via a latch.

12. The method of using a multi-leash handle of claim 10 wherein said front bar is openable via a hinged member; said hinged member being closed via a latch.

13. The method of using a multi-leash handle of claim 9 wherein said leash terminates in a clip opposite that of said plurality of rings to which said leash is affixed.

14. The method of using a multi-leash handle of claim 10 wherein said leash terminates in a clip opposite that of said plurality of rings to which said leash is affixed.

15. The method of using a multi-leash handle of claim 11 wherein said leash terminates in a clip opposite that of said plurality of rings to which said leash is affixed.

16. The method of using a multi-leash handle of claim 12 wherein said leash terminates in a clip opposite that of said plurality of rings to which said leash is affixed.
